(19) United States
(12) Patent Application Publication
(10) Pub. No.: US 2025/0168077 A1
(43) Pub. Date: May 22, 2025

(54) CONGESTION AWARE TRAFFIC OPTIMIZATION IN COMMUNICATION NETWORKS

(71) Applicant: Telefonaktiebolaget LM Ericsson (publ), Stockholm (SE)

(72) Inventors: Miguel Angel MUÑOZ DE LA TORRE ALONSO, Madrid (ES); Marcus IHLAR, Älvsjö (SE); Gonzalo HERNANDEZ HARO, Madrid (ES); Maria Luisa MAS ROSIQUE, Tres Cantos (ES)

(21) Appl. No.: 18/840,706

(22) PCT Filed: Jan. 18, 2023
(86) PCT No.: PCT/IB2023/050435

§ 371 Date: Aug. 22, 2024

(30) Foreign Application Priority Data
Feb. 23, 2022 (EP) 22382151.3

(51) Int. Cl. H04L 41/14; H04L 41/5009; H04W 28/06; H04W 76/12

(52) U.S. Cl. CPC H04L 41/14; H04L 41/5009; H04W 28/06; H04W 76/12

(57) ABSTRACT

Methods for a network data analytics function (NWDAF) of a communication network. Such methods include receiving, from user plane function (UPF) of the communications network, a first subscription request for an analytic related to user plane (UP) traffic congestion and sending to the UPF a second subscription request for information related to traffic between the UPF and a radio access network (RAN). Such methods also include receiving the traffic-related information from the UPF, in accordance with the second subscription request, and computing the analytic related to UP traffic congestion, based on the received traffic-related information. Such methods also include sending the computed analytic to the UPF, in accordance with the first subscription request. Embodiments also include complementary methods for UPFs, as well as NWDAFs and UPFs configured to perform such methods.

### TECHNICAL FIELD

The present application relates generally to the field of communication networks, and more specifically to techniques for generating traffic congestion analytics and applying such analytics for efficient and timely traffic optimization in a communication network (e.g., 5G network).

### Introduction

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of different functionalities such as session management, connection management, charging, authentication, etc.

FIG. 1 illustrates a high-level view of an exemplary 5G network architecture, consisting of a Next Generation Radio Access Network (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. Various other network functions (NFs) can be included in the 5GC 198, as described in more detail below.

In addition, the gNBs can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. A DU (e.g., gNB-DUs 120, 130) is a decentralized logical node that hosts lower layer protocols and can include, depending on the functional split option, various subsets of the gNB functions. As such, each of the CUs and DUs can include various circuitry needed to perform their respective functions, including processing circuitry, transceiver circuitry (e.g., for communication), and power supply circuitry.

A gNB-CU connects to one or more gNB-DUs over respective F1 logical interfaces, such as interfaces 122 and 132 shown in FIG. 1. However, a gNB-DU can be connected to only a single gNB-CU. The gNB-CU and connected gNB-DU(s) are only visible to other gNBs and the 5GC as a gNB. In other words, the F1 interface is not visible beyond gNB-CU.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations”, which are more granular divisions of the overall service functionality. The interactions between service consumers and producers can be of the type “request/response” or “subscribe/notify”. In the 5G SBA, network repository functions (NRF) allow every network function to discover the services offered by other network functions, and Data Storage Functions (DSF) allow every network function to store its context. This 5G SBA model is based on principles including modularity, reusability and self-containment of NFs, which can enable network deployments to take advantage of the latest virtualization and software technologies.

Network Data Analytics Function (NWDAF) is a 5GC NF that is of particular interest to the present disclosure. NWDAF provides network analytics information (e.g., statistical information of past events and/or predictive information) to other NFs. For example, NWDAF can provide analytics related to congestion experienced while transferring user data over control plane (CP) and/or user plane (UP). A request for user data congestion analytics relates to a specific area or to a specific user. If the consumer of these analytics provides a UE identifier (ID), the NWDAF determines the area where the UE is located, collects measurements per cell, and uses the measurements to determine user data congestion analytics.

### SUMMARY

Traffic volume in mobile networks is growing rapidly, particularly due to video traffic. MNOs apply different mechanisms for traffic optimization such as adaptive bit rate (ABR) shaping, large flow shaping, transmission control protocol (TCP) traffic optimization, etc. These mechanisms require inputs such as user data congestion in each cell, which are used to determine traffic optimization (e.g., specific ABR shaping profile to be applied for a certain flow) needed to mitigate the overall effects of congestion on user data traffic. Current congestion detection techniques are complex and require involvement of NWDAF, MDAF, and other NFs, thereby introducing undesirable latency in the inputs to traffic optimization. There is a need for simpler, more efficient, and more automated techniques to provide information about user data congestion for use by traffic optimization mechanisms.

Embodiments of the present disclosure address these and other problems, issues, and/or difficulties, thereby facilitating traffic optimization in 5G networks.

Some embodiments include exemplary methods (e.g., procedures) for an NWDAF of a communication network (e.g., 5GC).

These exemplary methods can include receiving, from a user plane function (UPF) of the communication network, a first subscription request for an analytic related to user plane (UP) traffic congestion. These exemplary methods can also include sending to the UPF a second subscription request for information related to traffic between the UPF and a radio access network (RAN). These exemplary methods can also include receiving the traffic-related information from the UPF, in accordance with the second subscription request. These exemplary methods can also include computing the analytic related to UP traffic congestion, based on the received traffic-related information. These exemplary methods can also include sending the computed analytic to the UPF, in accordance with the first subscription request.

In some embodiments, the first subscription request includes the following:
an identifier of the analytic;
an identifier of a tunnel between the UPF and the RAN, for which the analytic is requested;
identifiers of one or more UEs, for which the analytic is requested;
one or more other filtering criteria associated with the analytic;
one or more reporting criteria associated with the analytic;
a time period associated with the analytic; and
a required confidence level for the analytic.

In some embodiments, the second subscription request includes an event identifier associated with the second subscription request and identifiers of one or more of the following, for which the traffic-related information is requested:
a range of tunnels between the UPF and a RAN node, indicated by a tunnel range identifier or by an identifier of the RAN node;
one or more UEs;
one or more applications; and
one or more application types.

In some embodiments, these exemplary methods can also include determining the range of tunnels indicated in the second subscription request based on the identifier of the UPF tunnel in the first subscription request. In some embodiments, the traffic-related information received from the UPF includes the following:
aggregated volume of data traffic carried over the range of tunnels;
one or more key performance indicators (KPIs) for the aggregated data traffic carried over the range of tunnels; and
one or more of the following information associated with respective data flows carried over the range of tunnels: an identifier of a UE, an identifier of an application, flow data volume, flow start and stop times, flow duration, number of packets, average packet size, and other flow information relevant to congestion.

In some of these embodiments, the one or more KPIs include round trip time (RTI). In some of these embodiments, the analytic is a congestion level. In some of these embodiments, the congestion level is sent to the UPF according to one of the following:
based on the congestion level exceeding a reporting threshold identified in the first subscription request; or
periodically, according to a reporting period identified in the first subscription request.

In some of these embodiments, the congestion level is sent to the UPF together with one or more of the following:
one or more suggested action for the UPF, based on the congestion level;
one or more KPIs associated with the congestion level;
one or more statistics for user data sessions;
identifiers of active ones of the UEs identified in the first subscription request; and
level of confidence associated with the congestion level.
   In some variants, the one or more suggested actions for the UPF include any of the following: adaptive bit rate (ABR) shaping, large flow shaping, transmission control protocol (TCP) traffic optimization, and QUIC traffic optimization.

In some embodiments, multiple reports of traffic-related information are received from the UPF in accordance with the second subscription request, and each report includes an aggregated volume of data traffic carried over the range of tunnels. In such embodiments, computing the analytic includes determining a congestion level based on variations in the reported aggregate volumes of data traffic.

Other embodiments include methods (e.g., procedures) for a UPF of a communication network (e.g., 5GC).

These exemplary methods can include sending, an NWDAF of the communications network, a first subscription request for an analytic related to user plane (UP) traffic congestion. The exemplary method can include the operations of block 550, where the UPF can receive, from the NWDAF, a second subscription request for information related to traffic between the UPF and a radio access network (RAN). The exemplary method can include the operations of block 570, where the UPF can send the traffic-related information to the NWDAF, in accordance with the second subscription request. The exemplary method can include the operations of block 580, where the UPF can receive the analytic from the NWDAF, in accordance with the first subscription request.

In various embodiments, the first and second subscription requests can include any of the information mentioned above for those messages summarized above for NWDAF embodiments. Also, the traffic-related information can include any of the traffic-related information summarized above for NWDAF embodiments. In some embodiments, the analytic is a congestion level. In some embodiments, the congestion level is received from the NWDAF according to one of the following:
based on the congestion level exceeding a reporting threshold identified in the first subscription request; or
periodically, according to a reporting period identified in the first subscription request.

In some of these embodiments, the congestion level is received from the NWDAF together with one or more of the following:
one or more suggested action for the UPF, based on the congestion level;
one or more KPIs associated with the congestion level;
one or more statistics for user data sessions;
identifiers of active ones of the UEs identified in the first subscription request; and
level of confidence associated with the congestion level.
   In some variants, the one or more suggested actions for the UPF include any of the following: ABR shaping, large flow shaping, TCP traffic optimization, and QUIC traffic optimization.

In some embodiments, multiple reports of traffic-related information are sent to the NWDAF in accordance with the second subscription request, and each report includes an aggregated volume of data traffic carried over the range of tunnels. In such embodiments, the congestion level is based on variations in the reported aggregate volumes of data traffic.

In some embodiments, these exemplary method can also include performing one or more of the following optimization operations on traffic between the UPF and the RAN, based the analytic: ABR shaping, large flow shaping, TCP traffic optimization, and QUIC traffic optimization. In some variants, the UPF can perform suggested optimization operations received from the NWDAF together with the analytic.

In some embodiments, these exemplary methods can also include the following: receiving, from a session management function (SMF) of the communication network, a packet forwarding control protocol (PFCP) session establishment request that indicates a congestion-aware traffic optimization (CATO) policy; and establishing the tunnel between the UPF and the RAN, in accordance with the PCFP session establishment request. The first subscription request is sent in response to establishing the tunnel.

In some of these embodiments, these exemplary methods can also include sending to the SMF an indication that the UPF supports a CATO capability. The PFCP session establishment request is received based on the indication. In some variants, the PFCP session establishment request indicates that the UPF should apply the CATO policy without further interaction with the SMF.

In some embodiments, these exemplary methods can also include initiating collection of the traffic-related information based on detecting data traffic corresponding to the second subscription request. In some of these embodiments, the detected data traffic is associated with a UE and/or an application identified in the second subscription request.

Other embodiments include NWDAFs and UPFs (or network nodes hosting the same) that are configured to perform the operations corresponding to any of the exemplary methods described herein. Other embodiments also include non-transitory, computer-readable media storing computer-executable instructions that, when executed by processing circuitry associated with such NWDAFs and UPFs, configure the same to perform operations corresponding to any of the exemplary methods described herein.

These and other disclosed embodiments can facilitate mobile network operators (MNOs) to apply CATO techniques with various levels of granularity, such as per application, per subscriber, per subscriber group, per RAN node, etc. Embodiments can be applied locally (e.g., a UPF-associated NWDAF) and without the need for RAN data collection by operations and maintenance (O&M). Embodiments can also reduce latency in congestion detection compared to conventional approaches. At a high level, embodiments promote more efficient use of network resources and improve quality of experience (QoE) for end users.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

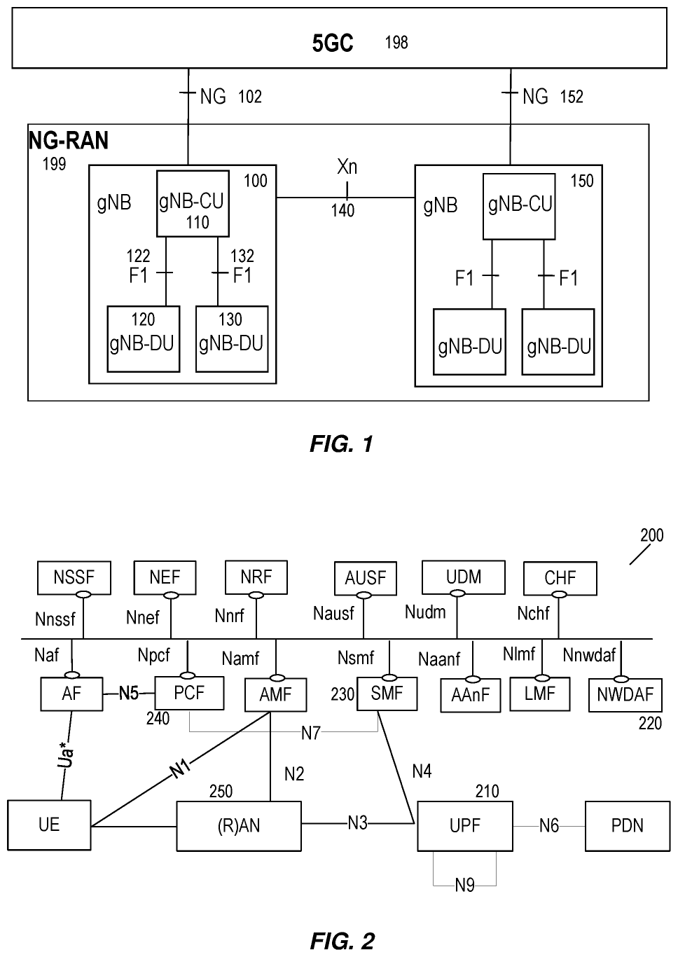

FIG. 3, which includes FIGS. 3A-D, shows an exemplary procedure for congestion-aware traffic optimization (CATO) in a communication (e.g., 5G) network, according to various embodiments of the present disclosure.

FIG. 4 shows an exemplary method (e.g., procedure) for an NWDAF of a communication network, according to various embodiments of the present disclosure.

FIG. 5 shows an exemplary method (e.g., procedure) for a UPF of a communication network, according to various embodiments of the present disclosure.

FIG. 6 shows an exemplary method (e.g., procedure) for an SMF of a communication network, according to various embodiments of the present disclosure.

FIG. 7 shows an exemplary method (e.g., procedure) for a PCF of a communication network, according to various embodiments of the present disclosure.

FIG. 8 shows a communication system according to various embodiments of the present disclosure.

FIG. 9 shows a UE according to various embodiments of the present disclosure.

FIG. 10 shows a network node according to various embodiments of the present disclosure.

FIG. 11 shows host computing system according to various embodiments of the present disclosure.

FIG. 12 is a block diagram of a virtualization environment in which functions implemented by some embodiments of the present disclosure may be virtualized.

FIG. 13 illustrates communication between a host computing system, a network node, and a UE via multiple connections, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.
Service: As used herein, the term “service” refers generally to a set of data, associated with one or more applications, which is to be transferred via a network with certain specific delivery requirements that need to be fulfilled in order to make the applications successful.
Component: As used herein, the term “component” refers generally to any component needed for the delivery of a service. Examples of component are RANs (e.g., E-UTRAN, NG-RAN, or portions thereof such as eNBs, gNBs, base stations (BS), etc.), CNs (e.g., EPC, 5GC, or portions thereof, including all type of links between RAN and CN entities), and cloud infrastructure with related resources such as computation, storage. In general, each component can have a “manager”, which is an entity that can collect historical information about utilization of resources as well as provide information about the current and the predicted future availability of resources associated with that component (e.g., a RAN manager).

Note that the description given herein focuses on a 3GPP telecommunications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a telecommunications device or a network node may be distributed over a plurality of telecommunications devices and/or network nodes.

FIG. 2 shows an exemplary non-roaming reference architecture for a 5G network (200) with service-based interfaces and various 3GPP-defined NFs within the Control Plane (CP). These include the following:
Application Function (AF) with Naf interface—interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, 240) with Npcf interface—supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF, 210)—supports handling of user plane traffic based on the rules received from SMF, including packet inspection and different enforcement actions (e.g., event detection/reporting, QoS handling, etc.). UPFs communicate with the RAN (250, e.g., NG-RAN/gNBs) via the N3 reference point, with SMFs (discussed below) via the N4 reference point, and with an external packet data network (PDN) via the N6 reference point. The N9 reference point is for communication between two UPFs.
Session Management Function (SMF, 230) with Nsmf interface—interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF) with Nchf interface—responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF) with Namf interface—terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to a 3GPP network. For example, NEF provides a service that allows an AF to provision specific subscription data (e.g., expected UE behavior) for various UEs.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF, 220) with Nnwdaf interface, described in more detail above and below.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.

Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

NRF allows every NF to discover the services offered by other NFs, and Data Storage Functions (DSF) allow every NF to store its context. In addition, the NEF provides exposure of capabilities and events of the 5GC to AFs within and outside of the 5GC. For example, NEF provides a service that allows an AF to provision specific subscription data (e.g., expected UE behavior) for various UEs.

A UE communicates with the CN over the Non-Access Stratum (NAS) and with the AN over the Access Stratum (AS). All the NAS communication takes place between the UE and the AMF via the NAS protocol (N1 interface in FIG. 2). Security for the communications over this these strata is provided by the NAS protocol (for NAS) and the PDCP protocol (for AS).

In addition to the operations mentioned above, the UPF also manages the CN Tunnel Info space, including CN Tunnel Info allocation and release. When new CN Tunnel Info is needed for a PDU session, the SMF requests (via N4) the UPF to allocate CN Tunnel Info for the applicable N3/N9 reference point. CN Tunnel Info is the CN address of a N3/N9 tunnel corresponding to the PDU Session, and a tunnel endpoint identifier (TEID) and an IP address used by the UPF on the N3/N9 GTP tunnel for the PDU Session. The PDU Session tunnel header includes the CN Tunnel Info, i.e., the N3/N9 GTP-U F-TEID.

3GPP Rel-17 enhances SBA by adding a Data Management Framework that includes a Data Collection Coordination Function (DCCF) and a Messaging Framework Adaptor Function (MFAF), which are defined in detail in 3GPP TR 23.700-91 (v17.0.0). The Data Management Framework is backward compatible with a Rel-16 NWDAF function, described above. For Rel-17, the baseline for services offered by the DCCF (e.g., to an NWDAF Analytics Function) are the Rel-16 NF Services used to obtain data. For example, the baseline for the DCCF service used by an NWDAF consumer to obtain UE mobility data is Namf_EventExposure.

3GPP TS 23.288 (v17.2.0) specifies that NWDAF is the main network function for computing analytic reports. The 5G system architecture allows any NF to obtain analytics from an NWDAF using a DCCF function and associated Ndccf services. The NWDAF can also perform storage and retrieval of analytics information from an Analytics Data Repository Function (ADRF), and can retrieve subscriber-related information from UDR via UDM and information about other NFs from NRF or NSSF (for slice-specific information). The NWDAF also provides data collection based on event subscription, provided by AMF, SMF, PCF, UDM, other AFs (directly or via NEF), and/or by OAM.

3GPP has also defined a Management Data Analytics Function (MDAF) at the network management level. The MDAF can retrieve operations, administration, and maintenance (OAM) data from NFs and the RAN (e.g., NG-RAN) and produce management analytics information and/or recommended management actions for the mobile network operator (MNO). MDAF-produced analytics can also be consumed by other management functions (MFs) in the OAM system, such as self-optimizing network (SON) functions.

3GPP TS 23.288 (v17.2.0) specifies that an NWDAF can provide to other NFs various analytics (e.g., statistics, predictions, etc.) related to congestion experienced while transferring user data over CP and/or UP. These user data congestion analytics can be provided via one-time or continuous (e.g., periodic) reporting. A consumer NF's (e.g., NEF, AF, PCF, etc.) request for user data congestion analytics can be related to a specific location area or to a specific user. If the consumer of these analytics provides a UE identifier (ID), NWDAF determines the area where the UE is located, collects measurements per cell, and uses the measurements to determine user data congestion analytics.

When requesting (or subscribing to) user data congestion analytics, the consumer NF can also request identities of the applications that contribute the most to the traffic in the area. The consumer request (or subscription) may indicate how many applications should be reported by specifying a maximum number of applications. The consumer request can also indicate a congestion threshold and the NWDAF will provide analytics when measured congestion level crosses the threshold. The consumer can also request user data congestion analytics on a per-slice level by including Single Network Slice Selection Assistance Information (S-NSSAI) in the request.

Traffic volume in mobile networks is growing rapidly, particularly due to video traffic. MNOs apply different mechanisms for traffic optimization such as adaptive bit rate (ABR) shaping, large flow shaping, transmission control protocol (TCP) traffic optimization, etc. These mechanisms require inputs such as user data congestion in each cell, which are used to determine the particular traffic optimization (e.g., specific ABR shaping profile to be applied for a certain flow) used to mitigate the overall effects of congestion on user data traffic.

User data congestion can be detected/estimated based on different mechanisms. One mechanism is via NWDAF, as discussed above. This mechanism requires both MDAF and NWDAF to receive RAN operations and maintenance (O&M) statistics, which adds significant complexity. Moreover, this mechanism does not produce real-time statistics.

A second mechanism is local congestion detection in UPF. However, this mechanism only detects congestion on a per-session basis and requires UPF to infer congestion from the user traffic sent in a specific session. As a result, detection accuracy can be less than desired.

To summarize, current congestion detection techniques are complex and require involvement of NWDAF, MDAF, and other NFs, thereby introducing undesirable latency and/or inaccuracy in the inputs to traffic optimization. There is a need for simpler, more efficient, and more automated techniques to provide information about user data congestion for use by traffic optimization mechanisms.

Accordingly, embodiments of the present disclosure address these and other problems, issues, and/or difficulties by a new and/or improved analytic that provides real-time, per-flow (and/or per-session) congestion awareness, based on which MNOs can apply congestion aware traffic optimization (CATO) techniques in a simple and effective way. Moreover, embodiments automate the congestion aware traffic optimization process at the UPF with a local, closed loop involving a minimum number of NFs, based on NWDAF detection or RAN congestion on a per-session and/or a per-flow basis.

In addition to these advantages, embodiments also facilitate MNOs to apply the CATO techniques with different levels of granularity, such as per application, per subscriber, per subscriber group, per RAN node, etc. Embodiments also can be applied locally (e.g., a UPF-associated NWDAF) and without the need for RAN data collection by O&M. Embodiments also facilitate reduced latency in congestion detection compared to conventional approaches. At a high level, embodiments promote more efficient use of network resources and improve quality of experience (QoE) for end users.

Embodiments can be summarized as follows. A new feature “congestion-aware traffic optimization” (or CATO, for short) can be enabled/disabled on a granular basis, such as per application, per subscriber, per subscriber group, per RAN node, etc. In the packet forwarding control protocol (PFCP) association procedure, a UPF reports to an SMF a new capability for CATO. This allows SMF to select a UPF supporting this capability on a per PFCP session basis. For a certain PDU session, when CATO needs to be applied, a consumer (e.g., UPF) subscribes to NWDAF for a congestion-related analytic (e.g., Analytic-ID=UPBasedCongestion), by providing information about where congestion detection is needed (e.g., a GTP tunnel ID, a RAN node associated with a tunnel, etc.) and optionally other distinguishing information. Based on this analytic subscription, NWDAF triggers data collection from UPF(s) connected to the gNB handling the PDU session.

For example, the UPF(s) for collection can correspond to a GTP Tunnel ID range that includes the GTP tunnel ID associated with tunnel created by UPF for the PDU session. Note that one or more UPFs can be connected to the same gNB, not only the UPF that requests the analytic. The NWDAF can determine (e.g., through local configuration or by OAM procedures) that the GTP Tunnel ID is part of a GTP Tunnel ID range that corresponds to a particular gNB.

A distributed NWDAF might perform data collection from nearby associated UPF(s), e.g., n UPFs connected to a particular gNB. Alternately, an NWDAF local to the particular UPF instance handling the PDU session (i.e., 1:1 mapping) can perform the data collection. More generally, the data collection can be deployment-specific.

Moreover, since data collection from UPF is for a GTP Tunnel ID Range rather than a specific GTP Tunnel ID, it is possible that data collection is ongoing and was previously initiated based on another PDU session. Thus, the analytic can provide aggregation of information from multiple PDU sessions over time. In that case, NWDAF might be sending multiple events (depending on event reporting policy) associated with other subscriptions for other PDU Sessions and/or other GTP Tunnel IDs that fall within the same range of collection.

Based on the collected data, the NWDAF runs analytic processes and generates the analytic to be provided to the consumer (e.g., UPF) in accordance with the subscription. Based on the congestion analytic, the consumer (e.g., UPF) performs traffic optimization operations such as ABR shaping, large flow shaping, TCP traffic optimization, QUIC traffic optimization, etc. Note the operations can be applied to the particular PDU session but they can also be applied to other active PDU sessions associated with a cell and/or RAN node where the congestion is detected.

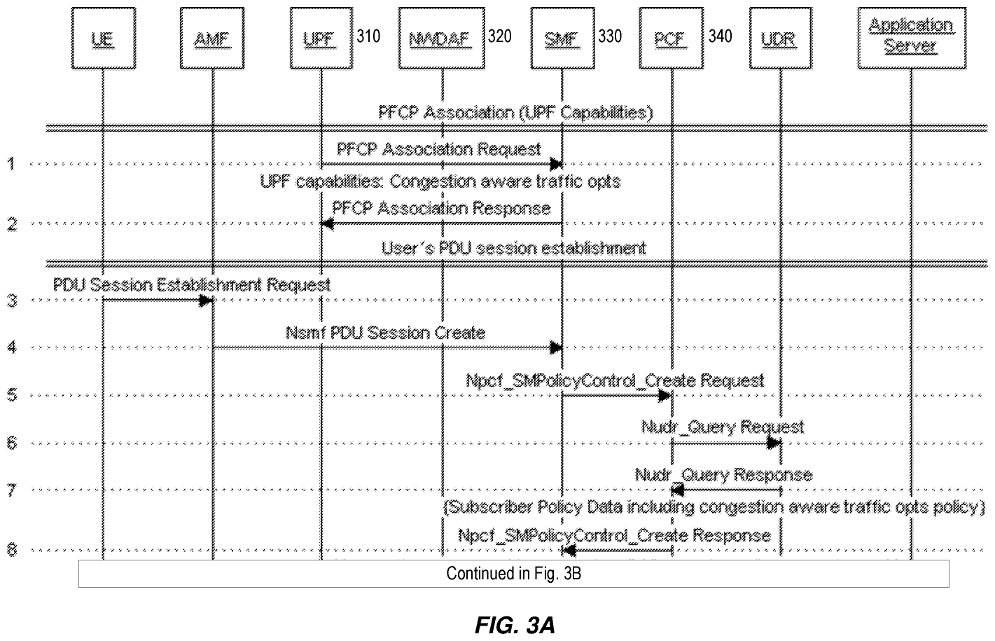

FIG. 3, which includes FIGS. 3A-D, shows an exemplary procedure for congestion-aware traffic optimization (CATO) in a communication (e.g., 5G) network, according to various embodiments of the present disclosure. Although the operations shown in FIG. 3 with numerical labels, this is done to facilitate explanation and neither implies nor requires a specific order or sequence of the operations, unless expressly stated to the contrary.

The procedure shown in FIG. 3 involves a UPF (310), an NWDAF (320), an SMF (330), and a PCF (340), as well as several other network functions. Although FIG. 3 shows a single UPF instance connected to a gNB for simplicity, principles illustrated by FIG. 3 are also applicable to arrangements where multiple UPFs are connected to a gNB.

As a precondition or prerequisite, a congestion aware traffic optimization policy is pre-configured in UDR as subscriber policy data. This policy could apply per subscriber, per group of subscribers, per network, per application, etc. This is a novel part of the invention.

Operations 1-2 are part of a PFCP Association procedure between UPF and SMF. In operation 1, UPF reports it capabilities to SMF. In some embodiments, the reported UPF capabilities (or features) can include a new capability for CATO. The table below shows an exemplary way for the UPF to indicate CATO capability, i.e., by adding a new bit (e.g., X=0 . . . 7) to one of the octets (e.g., Y) used to report UPF capabilities in the PFCP Association Request message. This is illustrated by the entry in the table below, which can be added to an existing table of UPF capabilities in a 3GPP specification.

| Feature | | | |
|---|---|---|---|
| Octet/Bit | Feature | Interface | Description |
| X/Y | CATO | Sxb, Sxc, N4 | Congestion aware traffic |
| | | | optimization is supported |
| | | | by the UP function. |

In operation 3, the UE triggers PDU session establishment by sending a PDU Session Establishment Request to AMF. For the sake of brevity, FIG. 3 does not show all signaling messages involved in the PDU Session Establishment procedure.

In operation 4, AMF selects an SMF to manage the PDU session and triggers an Nsmf_PDUSession_Create message. In operation 5, SMF selects a PCF and triggers an Npcf_SMPolicyControl_Create Request message to retrieve SM policies for the PDU session. In operation 6, PCF triggers an Nudr_Query Request message to retrieve the policy data for the PDU session. In operation 7, UDR answers with Nudr_Query Response including the Subscriber Policy Data, which includes a CATO policy.

In operation 8, PCF answers the request in operation 5 by triggering an Npcf_SMPolicyControl_Create Response that includes PCC rules for the PDU session (e.g., a PCC rule for the example.com application) and a CATO policy, which can indicate for SMF/UPF to apply the policy with or without further interaction with the PCF. In the procedure shown in FIG. 3, PCF delegates SMF/UPF to apply the traffic optimization policy based on the detected congestion level and does not require further interaction.

In operations 9-10, SMF selects a UPF supporting CATO and triggers a PFCP Session Establishment Request message including a CATO policy. In some embodiments, when the CATO policy applies on a per PFCP session basis, the PFCP protocol can be extended to include a new information element (IE) that indicates CATO policy, which can be included in messages such as PFCP Session Establishment Request and PFCP Session Modification Request. The procedure in FIG. 3 assumes there is an available UPF with CATO capability. In case there is no UPF with CATO capability, SMF will indicate that to PCF, from which PCF knows that the CATO policy cannot be met.

In operation 11, UPF acknowledges the request in operation 10 with a PFCP Session Establishment Response message. In operations 12-13, as part of the PFCP session establishment procedure, UPF allocates CN Tunnel Info for the N3 reference point (GTP Tunnel ID) and subscribes to NWDAF related to a new analytic (Analytic-ID=UPBasedCongestion), by triggering an Nnwdaf_AnalyticsSubscription_Subscribe request message including the following parameters:
Analytic-ID=UPBasedCongestion;
GTP Tunnel ID, i.e., where congestion detection is required to be detected;
UE-ID (optional);
other filtering criteria such as DNN, S-NSSAI, RAT-Type, etc.;
reporting type (e.g., periodic, event based, etc.);
time period during which the analytic applies (e.g., daily, weekly, monthly); and
confidence level required by the consumer.
   In some embodiments, the GTP Tunnel ID can be used by NWDAF to determine the GTP Tunnel ID Range and identify certain gNB and UPFs from where data can be collected. As an alternative, the Nnwdaf_AnalyticsSubscription_Subscribe request can include an identifier of a peer GTP node, a target gNB, etc.

In operation 14, NWDAF answers the request in operation 13 with a successful response (i.e., accepting the request). In operations 15-16, NWDAF triggers data collection from UPF, specifically for information related to traffic data for the connection towards a particular gNB, e.g., based on a certain GTP Tunnel ID range that corresponds to PDU sessions handled by a particular gNB. For example, NWDAF triggers a Nupf_EventExposure_Subscribe request message including the following parameters:
Event-ID=GTPTunnelData;
GTP Tunnel ID Range for the particular gNB. In general, this parameter indicates UPF to retrieve information relative to traffic data for the connection towards the gNB.
(optional) list of App-ID or App-Type for which the Event-ID applies. This is included in case congestion detection might be influenced by the application/s, e.g., the KPIs need to be interpreted differently depending on the application/s or application type that is/are generating the traffic.
(optional) UE-ID(s), indicating target UE(s) for which the Event-ID applies.
   In general, mechanisms described in 3GPP TR 23.700-91 (v17.0.0) can be used by the NWDAF to trigger data collection from UPF, e.g., via SMF or directly, assuming a service-based UPF.

In operation 17, UPF answers the request message in operation 16 with a successful response (i.e., accepting the request). In operations 18-19, the UE (user) starts an application (example.com) that sends application traffic. In operations 20-21, UPF detects the application traffic and gathers data for previously configured Event-ID=GTPTunnelData. In operations 22-23, UPF continues gathering this data and at some point (e.g., periodic reporting) reports data for Event-ID=GTPTunnelData. For example, the UPF notifies the NWDAF by triggering an Nupf_EventExposure_Notify request including Event-ID=GTPTunnelData and GTPTunnelDataInfo, which includes the following information:
Aggregated data traffic volume carried over GTP tunnel(s) within the GTP Tunnel ID Range (i.e., for all UE-IDs).
Aggregated KPIs for the data traffic carried over GTP tunnel(s) within the GTP Tunnel ID Range. For example, a round trip time (RTT) KPI can be done based on calculations using timestamps of header fields in transport-layer messages such as TCP SYN, TCP SYN ACK, and TCP ACK, and averaging across all flows. For encrypted transport (e.g., QUIC over UDP, as specified in IETF RFC 9000), KPIs such as QUIC spin bit can provide information relative to congestion.
For each detected flow carried over a GTP tunnel within the GTP Tunnel ID Range:
   UE-ID;
   App-ID;
   Flow start and stop times, and/or duration (e.g., timestamps);
   Other flow information (e.g., 5-tuple, ECN bits, QUIC spin bit) relevant to congestion;
   Flow volume (e.g., bytes, packets) optionally UL and DL volumes; and
   Number of packets and average packet size.

In operation 24, NWDAF answers the request in operation 23 with a successful response. In operation 25, NWDAF computes analytics based on the data collected from UPF. In some embodiments, the NWDAF can use Machine Learning (ML) to detect congestion. ML is a type of artificial intelligence (AI) that focuses on the use of data and algorithms to imitate the way that humans learn, gradually improving its accuracy. ML algorithms build models based on sample (or “training”) data, with the models being used subsequently to make predictions or decisions. ML algorithms can be used in a wide variety of applications (e.g., medicine, email filtering, speech recognition, etc.) in which it is difficult or unfeasible to develop conventional algorithms to perform the needed tasks.

In other embodiments, the NWDAF can detect congestion by identifying variations of KPIs, such as when aggregate traffic over the GTP tunnel(s) increases above a certain threshold. Based on this, NWDAF determines if congestion is happening or not.

In operation 26, NWDAF notifies the analytics consumer (e.g., UPF) by triggering a Nnwdaf_AnalyticsSubscription_Notify request message that includes Analytic-ID=UPBasedCongestion and an AnalyticResult comprising the following information:
congestion level (e.g., X);
(optional) suggested action for the consumer;
(optional) KPIs (e.g., RTT, average throughput, peak throughput, etc.);
(optional) statistics on user sessions (e.g., average number, standard deviation, etc.);
(optional) list of active UE-IDs (as a subset of subscribed UE-IDs);
level of confidence in the detected congestion level (e.g., 90% likelihood of congestion level=X).

In operation 27, UPF answers the request in operation 26 with a successful response. In operation 28, UPF applies the corresponding traffic optimization actions based on the congestion level indicated in the received AnalyticResult, e.g., ABR shaping, large flow shaping, TCP or QUIC traffic optimization for the PDU session, etc.

In various embodiments, the NWDAF can be a centralized NWDAF, a distributed NWDAF associated with a set of UPFs in an area or portion of a network, or an NWDAF that is associated and/or co-located with a single UPF. An NWDAF co-located with a UPF can provide the advantage of efficiency due to involvement of a minimum number of NFs.

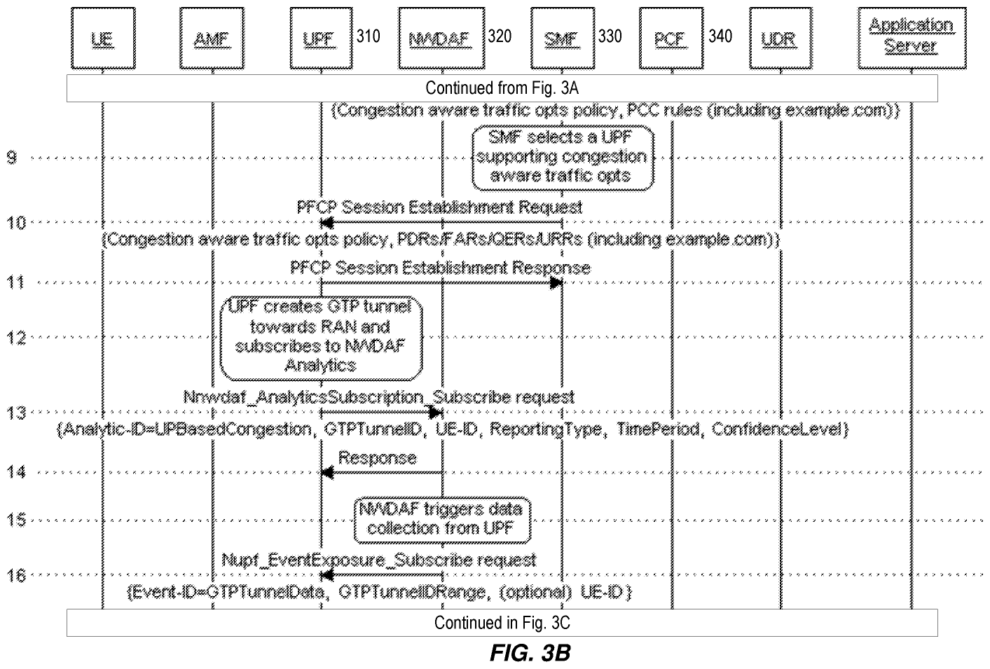

The embodiments described above can be further illustrated with reference to FIGS. 4-7, which depict exemplary methods (e.g., procedures) for an NWDAF, a UPF, a PCF, and an SMF, respectively. Put differently, various features of the operations described below correspond to various embodiments described above. The exemplary methods shown in FIGS. 4-7 can be used cooperatively (e.g., with each other and with other procedures described herein) to provide benefits, advantages, and/or solutions to problems described herein. Although the exemplary methods are illustrated in FIGS. 4-7 by specific blocks in particular orders, the operations corresponding to the blocks can be performed in different orders than shown and can be combined and/or divided into blocks and/or operations having different functionality than shown. Optional blocks and/or operations are indicated by dashed lines.

In particular, FIG. 4 illustrates an exemplary method (e.g., procedure) for an NWDAF of a communication network (e.g., 5GC), according to various embodiments of the present disclosure. For example, the exemplary method shown in FIG. 4 can be performed by an NWDAF (or network node hosting the same) such as described elsewhere herein.

The exemplary method can include the operations of block 410, where the NWDAF can receive, from a UPF of the communication network, a first subscription request for an analytic related to UP traffic congestion. The exemplary method can also include the operations of block 430, where the NWDAF can send to the UPF a second subscription request for information related to traffic between the UPF and a RAN (e.g., NG-RAN). The exemplary method can also include the operations of block 440, where the NWDAF can receive the traffic-related information from the UPF, in accordance with the second subscription request. The exemplary method can also include the operations of block 450, where the NWDAF can compute the analytic related to UP traffic congestion, based on the received traffic-related information. The exemplary method can also include the operations of block 460, where the NWDAF can send the computed analytic to the UPF, in accordance with the first subscription request.

In some embodiments, the first subscription request includes the following:
an identifier of the analytic;
an identifier of a tunnel between the UPF and the RAN, for which the analytic is requested;
identifiers of one or more UEs, for which the analytic is requested;
one or more other filtering criteria associated with the analytic;
one or more reporting criteria associated with the analytic;
a time period associated with the analytic; and
a required confidence level for the analytic.

In some embodiments, the second subscription request includes an event identifier associated with the second subscription request and identifiers of one or more of the following, for which the traffic-related information is requested:
a range of tunnels between the UPF and a RAN node, indicated by a tunnel range identifier or by an identifier of the RAN node;
one or more UEs;
one or more applications; and
one or more application types.

In some embodiments, the exemplary method can also include the operations of block 420, where the NWDAF can determine the range of tunnels indicated in the second subscription request based on the identifier of the UPF tunnel in the first subscription request. In some embodiments, the traffic-related information received from the UPF includes the following:
aggregated volume of data traffic carried over the range of tunnels;
one or more key performance indicators (KPIs) for the aggregated data traffic carried over the range of tunnels; and
one or more of the following information associated with respective data flows carried over the range of tunnels: an identifier of a UE, an identifier of an application, flow data volume, flow start and stop times, flow duration, number of packets, average packet size, and other flow information relevant to congestion.

In some of these embodiments, the one or more KPIs include round trip time (RTT). In some of these embodiments, the analytic (e.g., computed in block 450) is a congestion level. In some of these embodiments, the congestion level is sent to the UPF (e.g., in block 460) according to one of the following:
based on the congestion level exceeding a reporting threshold identified in the first subscription request; or
periodically, according to a reporting period identified in the first subscription request.

In some of these embodiments, the congestion level is sent to the UPF (e.g., in block 460) together with one or more of the following:
one or more suggested action for the UPF, based on the congestion level;
one or more KPIs associated with the congestion level;
one or more statistics for user data sessions;
identifiers of active ones of the UEs identified in the first subscription request; and
level of confidence associated with the congestion level.
   In some variants, the one or more suggested actions for the UPF include any of the following: adaptive bit rate (ABR) shaping, large flow shaping, transmission control protocol (TCP) traffic optimization, and QUIC traffic optimization.

In some embodiments, multiple reports of traffic-related information are received from the UPF in accordance with the second subscription request, and each report includes an aggregated volume of data traffic carried over the range of tunnels. In such embodiments, computing the analytic in block 450 includes the operations of sub-block 451, where the NWDAF can determine a congestion level based on variations in the reported aggregate volumes of data traffic.

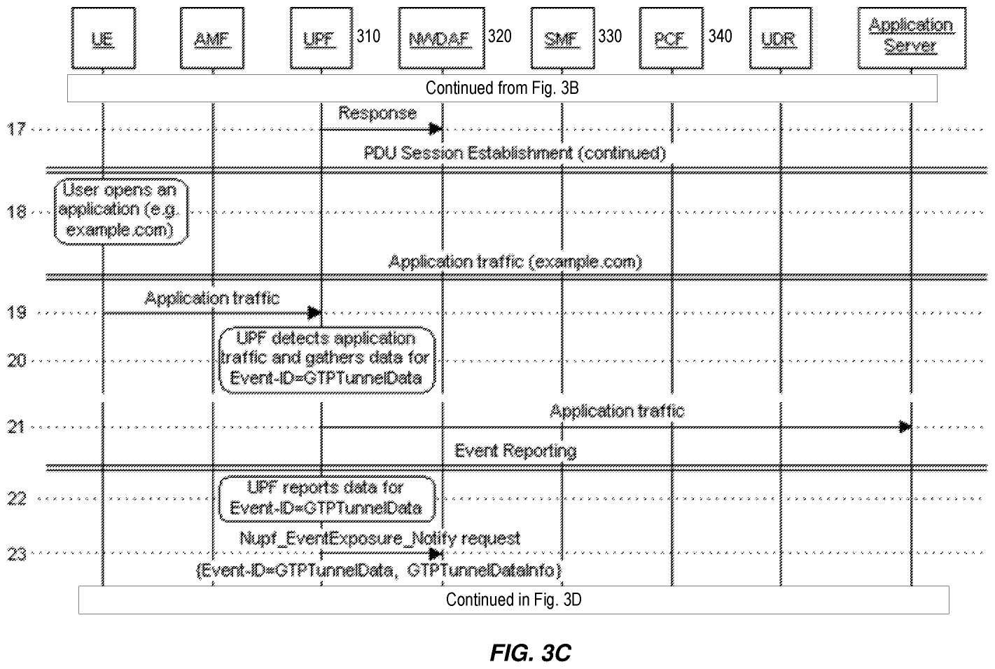

In addition, FIG. 5 illustrates an exemplary method (e.g., procedure) for a UPF of a communication network (e.g., 5GC), according to various embodiments of the present disclosure. For example, the exemplary method shown in FIG. 5 can be performed by a UPF (or a network node hosting the same) such as described elsewhere herein.

The exemplary method can include the operations of block 540, where the UPF can send, to an NWDAF of the communications network, a first subscription request for an analytic related to UP traffic congestion. The exemplary method can include the operations of block 550, where the UPF can receive, from the NWDAF, a second subscription request for information related to traffic between the UPF and a RAN (e.g., NG-RAN). The exemplary method can include the operations of block 570, where the UPF can send the traffic-related information to the NWDAF, in accordance with the second subscription request. The exemplary method can include the operations of block 580, where the UPF can receive the analytic from the NWDAF, in accordance with the first subscription request.

In various embodiments, the first and second subscription requests can include any of the information mentioned above for those messages in the description of NWDAF embodiments illustrated by FIG. 4. Also, the traffic-related information can include any of the traffic-related information mentioned above in the description of NWDAF embodiments illustrated by FIG. 4.

In some embodiments, the analytic is a congestion level. In some embodiments, the congestion level is received from the NWDAF (e.g., in block 580) according to one of the following:
based on the congestion level exceeding a reporting threshold identified in the first subscription request; or
periodically, according to a reporting period identified in the first subscription request.

In some of these embodiments, the congestion level is received from the NWDAF (e.g., in block 580) together with one or more of the following:
one or more suggested action for the UPF, based on the congestion level;
one or more KPIs associated with the congestion level;
one or more statistics for user data sessions;
identifiers of active ones of the UEs identified in the first subscription request; and
level of confidence associated with the congestion level.
   In some variants, the one or more suggested actions for the UPF include any of the following: ABR shaping, large flow shaping, TCP traffic optimization, and QUIC traffic optimization.

In some embodiments, multiple reports of traffic-related information are sent to the NWDAF in accordance with the second subscription request, and each report includes an aggregated volume of data traffic carried over the range of tunnels. In such embodiments, the congestion level (e.g., received in block 580) is based on variations in the reported aggregate volumes of data traffic.

In some embodiments, the exemplary method can also include the operations of block 590, where the UPF can perform one or more of the following optimization operations on traffic between the UPF and the RAN, based the analytic: ABR shaping, large flow shaping, TCP traffic optimization, and QUIC traffic optimization. In some variants, the UPF can perform suggested optimization operations received from the NWDAF together with the analytic (e.g., in block 580).

In some embodiments, the exemplary method can also include the operations of blocks 520-530. In block 520, the UPF can receive, from a session management function (SMF) of the communication network, a packet forwarding control protocol (PFCP) session establishment request that indicates a congestion-aware traffic optimization (CATO) policy. In block 530, the UPF can establish the tunnel between the UPF and the RAN, in accordance with the PCFP session establishment request. The first subscription request is sent (e.g., in block 540) in response to establishing the tunnel.

In some of these embodiments, the exemplary method can also include the operations of block 510, where the UPF can send, to the SMF, an indication that the UPF supports a CATO capability. The PFCP session establishment request is received (e.g., in block 520) based on the indication. In some variants, the PFCP session establishment request indicates that the UPF should apply the CATO policy without further interaction with the SMF.

In some embodiments, the exemplary method can also include the operations of block 560, where the UPF can initiate collection of the traffic-related information based on detecting data traffic corresponding to the second subscription request. In some of these embodiments, the detected data traffic is associated with one or more of the following identified in the second subscription request: a UE, and an application.

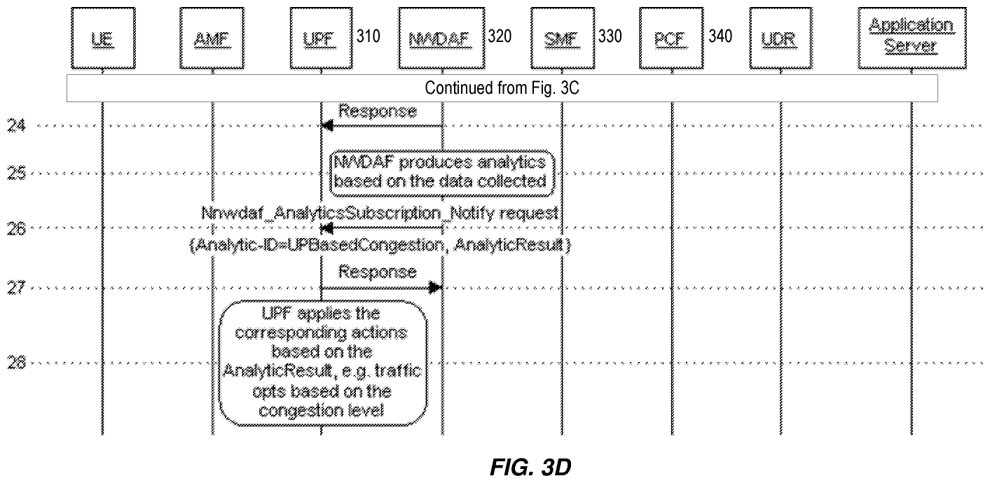

In addition, FIG. 6 illustrates an exemplary method (e.g., procedure) for an SMF of a communication network (e.g., 5GC), according to various embodiments of the present disclosure. For example, the exemplary method shown in FIG. 6 can be performed by an SMF (or a network node hosting the same) such as described elsewhere herein.

The exemplary method can include the operations of block 620, where the SMF can receive, from an AMF of the communication network, a request to create a PDU session for a UE. The exemplary method can also include the operations of block 630, where the SMF can send, to a PCF of the communication network, a request for session management (SM) policies related to the PDU session. The exemplary method can also include the operations of block 640, where the SMF can receive, from the PCF, a response that includes a CATO policy applicable to the PDU session. The exemplary method can also include the operations of block 660, where the SMF can send, to a UPF of the communication network, a packet forwarding control protocol (PFCP) session establishment request that relates to the PDU session and that indicates the CATO policy.

In some embodiments, the exemplary method can also include the operations of blocks 610 and 650, where the SMF can receive from the UPF an indication that the UPF supports a CATO capability and select the UPF for establishment of the PFCP session based on the indication (i.e., based on that the UPF supports CATO).

In some embodiments, the response from the PCF (e.g., in block 640) indicates that the SMF should apply the CATO policy without further interaction with the PCF.

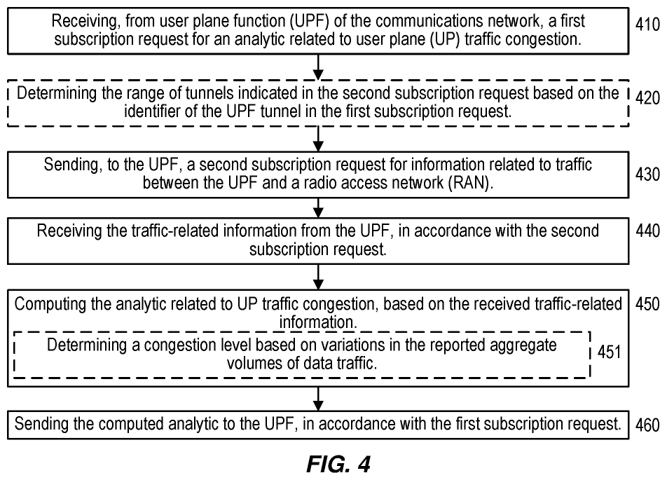

In addition, FIG. 7 illustrates an exemplary method (e.g., procedure) for PCF of a communication network (e.g., 5GC), according to various embodiments of the present disclosure. For example, the exemplary method shown in FIG. 7 can be performed by a PCF (or a network node hosting the same) such as described elsewhere herein.

The exemplary method can include the operations of block 710, where the PCF can receive, from an SMF of the communication network, a request for SM policies related to a PDU session for a UE. The exemplary method can also include the operations of block 720, where the PCF can retrieve the SM policies for the PDU session from a UDR of the communication network. The retrieved SM policies include a CATO policy. The exemplary method can also include the operations of block 730, where the PCF can send to the SMF a response that includes the CATO policy. In some embodiments, the response to the SMF indicates that the SMF should apply the CATO policy without further interaction with the PCF.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

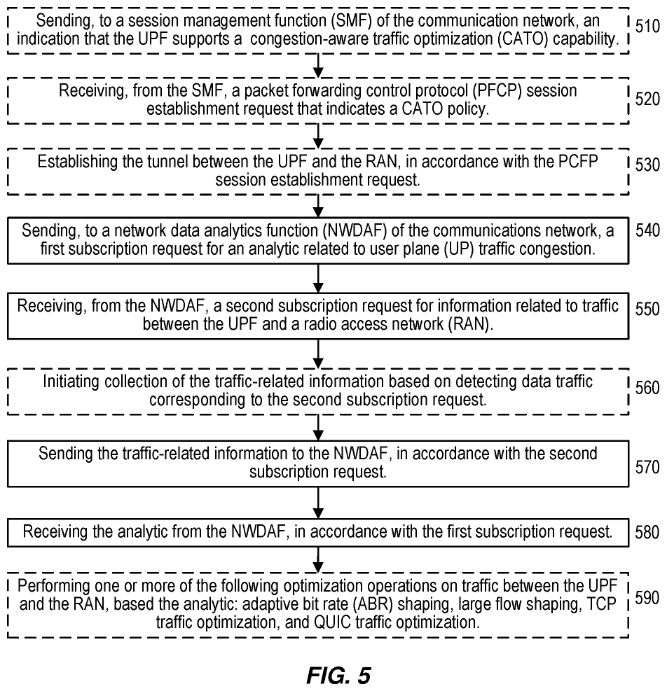

FIG. 8 shows an example of a communication system 800 in accordance with some embodiments. In this example, communication system 800 includes a telecommunication network 802 that includes an access network 804 (e.g., RAN) and a core network 806, which includes one or more core network nodes 808. Access network 804 includes one or more access network nodes, such as network nodes 810a-b (one or more of which may be generally referred to as network nodes 810), or any other similar 3GPP access node or non-3GPP access point. Network nodes 810 facilitate direct or indirect connection UEs, such as by connecting UEs 812a-d (one or more of which may be generally referred to as UEs 812) to core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 800 may include any number of wired or wireless networks, network nodes, UEs, and/or any other components or systems that may facilitate or participate in the communication of data and/or signals whether via wired or wireless connections. Communication system 800 may include and/or interface with any type of communication, telecommunication, data, cellular, radio network, and/or other similar type of system.

UEs 812 may be any of a wide variety of communication devices, including wireless devices arranged, configured, and/or operable to communicate wirelessly with network nodes 810 and other communication devices. Similarly, network nodes 810 are arranged, capable, configured, and/or operable to communicate directly or indirectly with UEs 812 and/or with other network nodes or equipment in telecommunication network 802 to enable and/or provide network access, such as wireless network access, and/or to perform other functions, such as administration in telecommunication network 802.

In the depicted example, core network 806 connects network nodes 810 to one or more hosts, such as host 816. These connections may be direct or indirect via one or more intermediary networks or devices. In other examples, network nodes may be directly coupled to hosts. Core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), User Plane Function (UPF), Policy Control Function (PCF), and Network Data Analytics Function (NWDAF).

Host 816 may be under the ownership or control of a service provider other than an operator or provider of access network 804 and/or telecommunication network 802, and may be operated by the service provider or on behalf of the service provider. Host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 802 is a cellular network that implements 3GPP standardized features. Accordingly, telecommunication network 802 may support network slicing to provide different logical networks to different devices that are connected to telecommunication network 802. For example, telecommunication network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 812 are configured to transmit and/or receive information without direct human interaction. For instance, a UE may be designed to transmit information to access network 804 on a predetermined schedule, when triggered by an internal or external event, or in response to requests from access network 804. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, hub 814 communicates with access network 804 to facilitate indirect communication between one or more UEs (e.g., UE 812c and/or 812d) and network nodes (e.g., network node 810b). In some examples, hub 814 may be a controller, router, content source and analytics, or any of the other communication devices described herein regarding UEs. For example, hub 814 may be a broadband router enabling access to core network 806 for the UEs. As another example, hub 814 may be a controller that sends commands or instructions to one or more actuators in the UEs. Commands or instructions may be received from the UEs, network nodes 810, or by executable code, script, process, or other instructions in hub 814. As another example, hub 814 may be a data collector that acts as temporary storage for UE data and, in some embodiments, may perform analysis or other processing of the data. As another example, hub 814 may be a content source. For example, for a UE that is a VR headset, display, loudspeaker or other media delivery device, hub 814 may retrieve VR assets, video, audio, or other media or data related to sensory information via a network node, which hub 814 then provides to the UE either directly, after performing local processing, and/or after adding additional local content. In still another example, hub 814 acts as a proxy server or orchestrator for the UEs, in particular in if one or more of the UEs are low energy IoT devices.

Hub 814 may have a constant/persistent or intermittent connection to the network node 810b. Hub 814 may also allow for a different communication scheme and/or schedule between hub 814 and UEs (e.g., UE 812c and/or 812d), and between hub 814 and core network 806. In other examples, hub 814 is connected to core network 806 and/or one or more UEs via a wired connection. Moreover, hub 814 may be configured to connect to an M2M service provider over access network 804 and/or to another UE over a direct connection. In some scenarios, UEs may establish a wireless connection with network nodes 810 while still connected via hub 814 via a wired or wireless connection. In some embodiments, hub 814 may be a dedicated hub—that is, a hub whose primary function is to route communications to/from the UEs from/to the network node 810b. In other embodiments, hub 814 may be a non-dedicated hub—that is, a device which is capable of operating to route communications between the UEs and network node 810b, but which is additionally capable of operating as a communication start and/or end point for certain data channels.

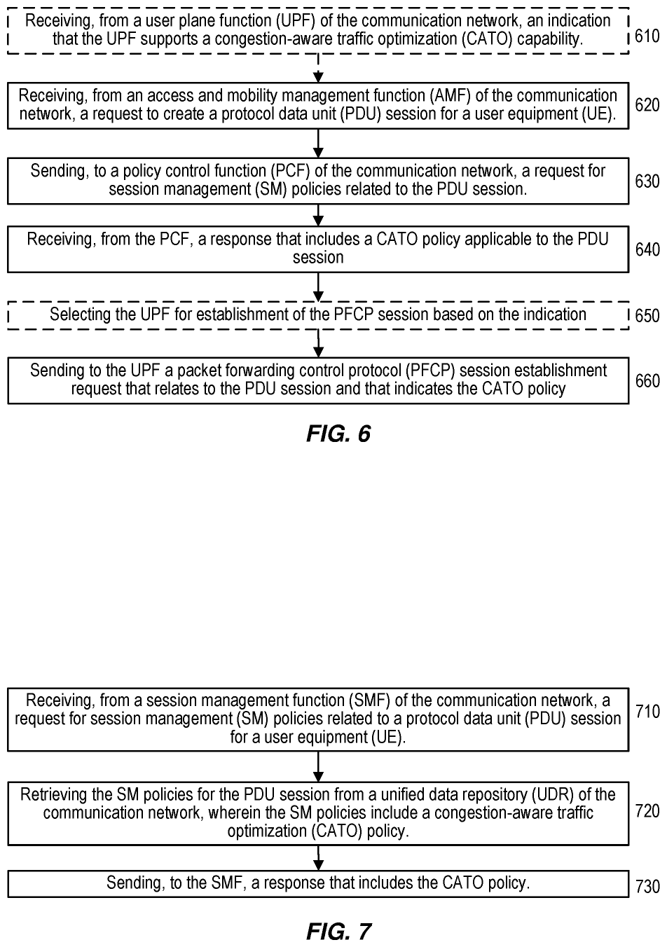

FIG. 9 shows a UE 900 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

Processing circuitry 902 is configured to process instructions and data and may be configured to implement any sequential state machine operative to execute instructions stored as machine-readable computer programs in memory 910. Processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 902 may include multiple central processing units (CPUs).

In the example, input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 908 is structured as a battery or battery pack. Other types of power sources, such as an external power source (e.g., an electricity outlet), photovoltaic device, or power cell, may be used. Power source 908 may further include power circuitry for delivering power from power source 908 itself, and/or an external power source, to the various parts of UE 900 via input circuitry or an interface such as an electrical power cable. Delivering power may be, for example, for charging of power source 908. Power circuitry may perform any formatting, converting, or other modification to the power from power source 908 to make the power suitable for the respective components of UE 900 to which power is supplied.

Memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 910 includes one or more application programs 914, such as an operating system, web browser application, a widget, gadget engine, or other application, and corresponding data 916. Memory 910 may store, for use by UE 900, any of a variety of various operating systems or combinations of operating systems.

Memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 910 may allow UE 900 to access instructions, application programs and the like, stored on transitory or non-transitory memory media, to off-load data, or to upload data. An article of manufacture, such as one utilizing a communication system may be tangibly embodied as or in memory 910, which may be or comprise a device-readable storage medium.

Processing circuitry 902 may be configured to communicate with an access network or other network using communication interface 912. Communication interface 912 may comprise one or more communication subsystems and may include or be communicatively coupled to an antenna 922. Communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, transmitter 918 and receiver 920 may be coupled to one or more antennas (e.g., antenna 922) and may share circuit components, software or firmware, or alternatively be implemented separately.

In the illustrated embodiment, communication functions of communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

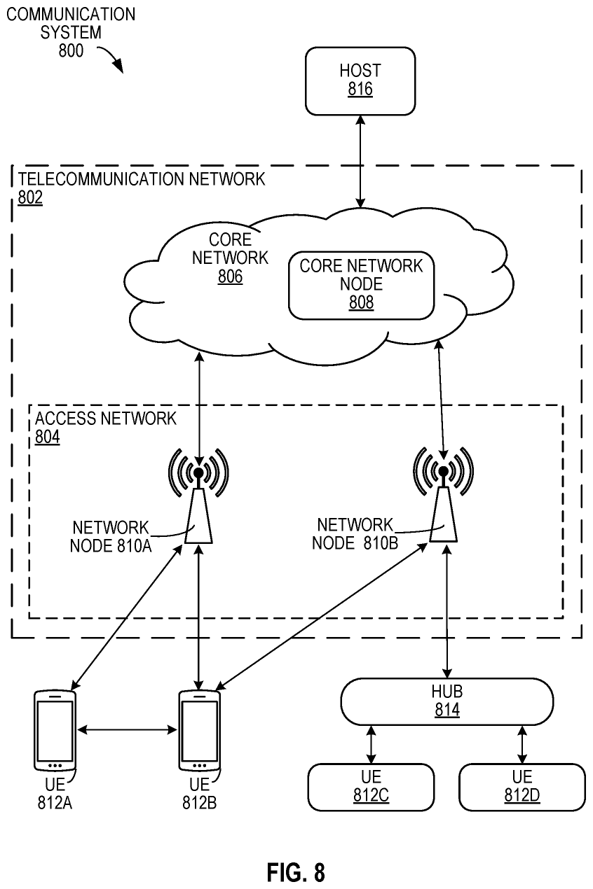

FIG. 10 shows a network node 1000 in accordance with some embodiments. Examples of network nodes that can be implemented according to FIG. 10 include, but are not limited to, access points (e.g., radio access points), base stations (e.g., radio base stations, Node Bs, eNBs, gNBs, ng-eNBs, etc.), and core network nodes (e.g., MMEs, SGWs, SMFs, AMFs, AUSFs, UDMs, NEFs, UPFs, PCFs, NWDAFs, etc.).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1000 includes a processing circuitry 1002, a memory 1004, a communication interface 1006, and a power source 1008. Network node 1000 may be composed of multiple physically separate components (e.g., a NodeB component and a RNC component, or a BTS component and a BSC component, etc.), which may each have their own respective components. In certain scenarios in which network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). Network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

Processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as memory 1004, to provide network node 1000 functionality.

In some embodiments, processing circuitry 1002 includes a system on a chip (SOC). In some embodiments, processing circuitry 1002 includes radio frequency (RF) transceiver circuitry 1012 and/or baseband processing circuitry 1014. In some embodiments, RF transceiver circuitry 1012 and baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

Memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1002. Memory 1004 may store any suitable instructions, data, or information, including a computer program, software, an application including one or more of logic, rules, code, tables, and/or other instructions (collectively denoted computer program product 1004a) capable of being executed by processing circuitry 1002 and utilized by network node 1000. Memory 1004 may be used to store any calculations made by processing circuitry 1002 and/or any data received via communication interface 1006. In some embodiments, processing circuitry 1002 and memory 1004 is integrated.

Communication interface 1006 is used in wired or wireless communication of signaling and/or data between a network node, access network, and/or UE. As illustrated, communication interface 1006 comprises port(s)/terminal(s) 1016 to send and receive data, for example to and from a network over a wired connection. Communication interface 1006 also includes radio front-end circuitry 1018 that may be coupled to, or in certain embodiments a part of, antenna 1010. Radio front-end circuitry 1018 comprises filters 1020 and amplifiers 1022. Radio front-end circuitry 1018 may be connected to an antenna 1010 and processing circuitry 1002. The radio front-end circuitry may be configured to condition signals communicated between antenna 1010 and processing circuitry 1002. Radio front-end circuitry 1018 may receive digital data that is to be sent out to other network nodes or UEs via a wireless connection. Radio front-end circuitry 1018 may convert the digital data into a radio signal having the appropriate channel and bandwidth parameters using a combination of filters 1020 and/or amplifiers 1022. The radio signal may then be transmitted via antenna 1010. Similarly, when receiving data, antenna 1010 may collect radio signals which are then converted into digital data by radio front-end circuitry 1018. The digital data may be passed to processing circuitry 1002. In other embodiments, the communication interface may comprise different components and/or different combinations of components.

In certain alternative embodiments, network node 1000 does not include separate radio front-end circuitry 1018, instead, processing circuitry 1002 includes radio front-end circuitry and is connected to antenna 1010. Similarly, in some embodiments, all or some of the RF transceiver circuitry 1012 is part of communication interface 1006. In still other embodiments, communication interface 1006 includes one or more ports or terminals 1016, radio front-end circuitry 1018, and RF transceiver circuitry 1012, as part of a radio unit (not shown), and communication interface 1006 communicates with baseband processing circuitry 1014, which is part of a digital unit (not shown).

Antenna 1010 may include one or more antennas, or antenna arrays, configured to send and/or receive wireless signals. Antenna 1010 may be coupled to radio front-end circuitry 1018 and may be any type of antenna capable of transmitting and receiving data and/or signals wirelessly. In certain embodiments, antenna 1010 is separate from network node 1000 and connectable to network node 1000 through an interface or port.

Antenna 1010, communication interface 1006, and/or processing circuitry 1002 may be configured to perform any receiving operations and/or certain obtaining operations described herein as being performed by the network node. Any information, data and/or signals may be received from a UE, another network node and/or any other network equipment. Similarly, antenna 1010, communication interface 1006, and/or processing circuitry 1002 may be configured to perform any transmitting operations described herein as being performed by the network node. Any information, data and/or signals may be transmitted to a UE, another network node and/or any other network equipment.

Power source 1008 provides power to the various components of network node 1000 in a form suitable for the respective components (e.g., at a voltage and current level needed for each respective component). Power source 1008 may further comprise, or be coupled to, power management circuitry to supply the components of network node 1000 with power for performing the functionality described herein. For example, network node 1000 may be connectable to an external power source (e.g., the power grid, an electricity outlet) via an input circuitry or interface such as an electrical cable, whereby the external power source supplies power to power circuitry of power source 1008. As a further example, power source 1008 may comprise a source of power in the form of a battery or battery pack which is connected to, or integrated in, power circuitry. The battery may provide backup power should the external power source fail.

Embodiments of network node 1000 may include additional components beyond those shown in FIG. 10 for providing certain aspects of the network node's functionality, including any of the functionality described herein and/or any functionality necessary to support the subject matter described herein. For example, network node 1000 may include user interface equipment to allow input of information into network node 1000 and to allow output of information from network node 1000. This may allow a user to perform diagnostic, maintenance, repair, and other administrative functions for network node 1000.

In some embodiments, network node 100 may be used to implement and/or host one or more NFs described herein, such as NWDAF, UPF, SMF, PCF, etc. In other words, network node 1000 (and its components, such as processing circuitry 1002) can be configured to perform operations corresponding to any of the methods (e.g., procedures) described herein as being performed by NFs such as NWDAF, UPF, SMF, PCF, etc.

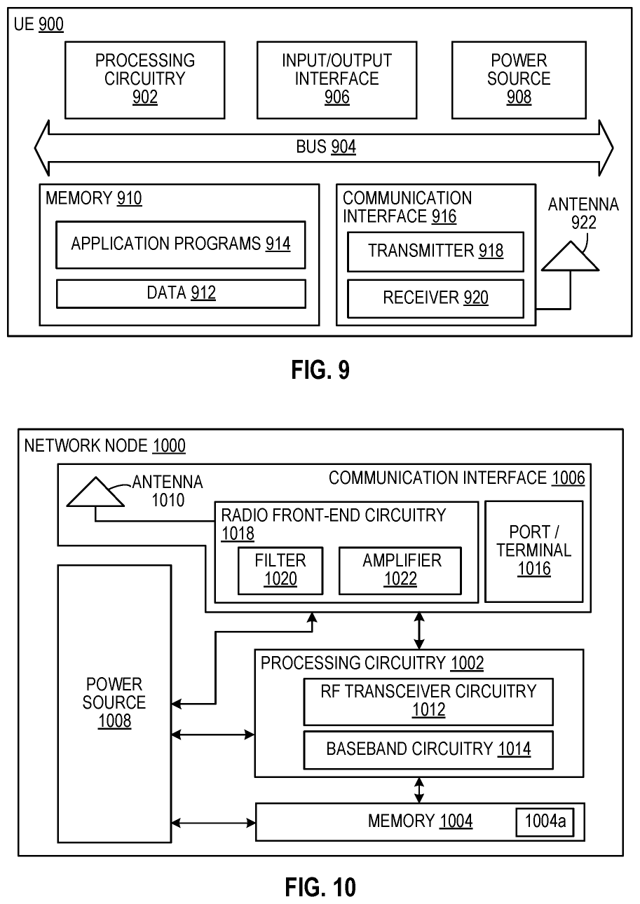

FIG. 11 is a block diagram of a host 1100, which may be an embodiment of host 816 of FIG. 8, in accordance with various aspects described herein. Host 1100 may be or comprise various combinations hardware and/or software, including a standalone server, a blade server, a cloud-implemented server, a distributed server, a virtual machine, container, or processing resources in a server farm. Host 1100 may provide one or more services to one or more UEs.

Host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

Memory 1112 may include one or more computer programs including one or more host application programs 1114 and data 1116, which may include user data, e.g., data generated by a UE for host 1100 or data generated by host 1100 for a UE. Embodiments of host 1100 may utilize only a subset or all of the components shown. Host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1114 may also provide for user authentication and licensing checks and may periodically report health, routes, and content availability to a central node, such as a device in or on the edge of a core network. Accordingly, host 1100 may select and/or indicate a different host for over-the-top services for a UE. Host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

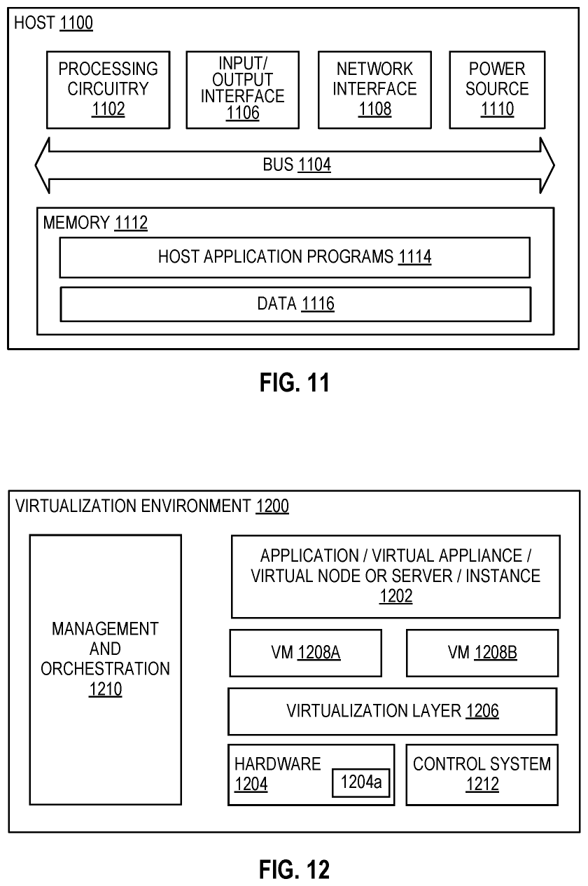

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1204 includes processing circuitry, memory that stores software and/or instructions (collectively denoted computer program product 1204a) executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a-b (one or more of which may be generally referred to as VMs 1208), and/or perform any of the functions, features and/or benefits described in relation with some embodiments described herein. Virtualization layer 1206 may present a virtual operating platform that appears like networking hardware to the VMs 1208.

VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of VMs 1208, and that part of hardware 1204 that executes that VM (e.g., hardware dedicated to that VM and/or hardware shared by that VM with other VMs) forms separate virtual network elements. Still in the context of NFV, a virtual network function is responsible for handling specific network functions that run in one or more VMs 1208 on top of hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g., such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

In some embodiments, virtualization environment 1200 may be used to implemented one or more NFs described herein, such as NWDAFs, UPFs, SMFs, PCFs, etc. In other words, one or more VMs 1208 and underlying hardware 1204 can be configured to perform operations corresponding to any of the methods (e.g., procedures) described herein as being performed by NFs such as NWDAFs, UPFs, SMFs, PCFs, etc.

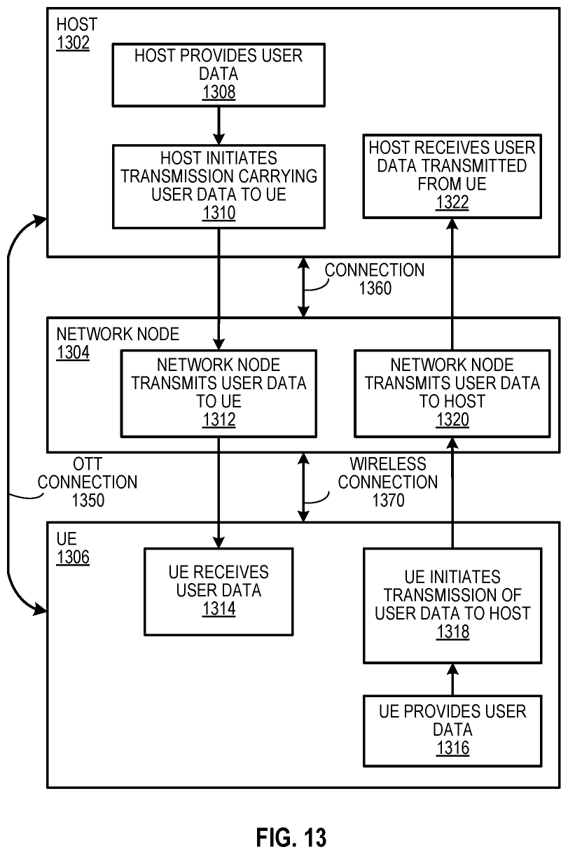

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. Host 1302 also includes software, which is stored in or accessible by host 1302 and executable by the processing circuitry. The software includes a host application that may be operable to provide a service to a remote user, such as UE 1306 connecting via an over-the-top (OTT) connection 1350 extending between UE 1306 and host 1302. In providing the service to the remote user, a host application may provide user data which is transmitted using OTT connection 1350.

Network node 1304 includes hardware enabling it to communicate with host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of host 1302. In host 1302, an executing host application may communicate with the executing client application via OTT connection 1350 terminating at UE 1306 and host 1302. In providing the service to the user, the UE's client application may receive request data from the host's host application and provide user data in response to the request data. OTT connection 1350 may transfer both the request data and the user data. The UE's client application may interact with the user to generate the user data that it provides to the host application through OTT connection 1350.

OTT connection 1350 may extend via a connection 1360 between host 1302 and network node 1304 and via a wireless connection 1370 between network node 1304 and UE 1306 to provide the connection between host 1302 and UE 1306. Connection 1360 and wireless connection 1370, over which OTT connection 1350 may be provided, have been drawn abstractly to illustrate the communication between host 1302 and UE 1306 via network node 1304, without explicit reference to any intermediary devices and the precise routing of messages via these devices.

As an example of transmitting data via OTT connection 1350, in step 1308, host 1302 provides user data, which may be performed by executing a host application. In some embodiments, the user data is associated with a particular human user interacting with UE 1306. In other embodiments, the user data is associated with a UE 1306 that shares data with host 1302 without explicit human interaction. In step 1310, host 1302 initiates a transmission carrying the user data towards UE 1306. Host 1302 may initiate the transmission responsive to a request transmitted by UE 1306. The request may be caused by human interaction with UE 1306 or by operation of the client application executing on UE 1306. The transmission may pass via network node 1304, in accordance with the teachings of the embodiments described throughout this disclosure. Accordingly, in step 1312, network node 1304 transmits to UE 1306 the user data that was carried in the transmission that host 1302 initiated, in accordance with the teachings of the embodiments described throughout this disclosure. In step 1314, UE 1306 receives the user data carried in the transmission, which may be performed by a client application executed on UE 1306 associated with the host application executed by host 1302.

In some examples, UE 1306 executes a client application which provides user data to host 1302. The user data may be provided in reaction or response to the data received from host 1302. Accordingly, in step 1316, UE 1306 may provide user data, which may be performed by executing the client application. In providing the user data, the client application may further consider user input received from the user via an input/output interface of UE 1306. Regardless of the specific manner in which the user data was provided, UE 1306 initiates, in step 1318, transmission of the user data towards host 1302 via network node 1304. In step 1320, in accordance with the teachings of the embodiments described throughout this disclosure, network node 1304 receives user data from UE 1306 and initiates transmission of the received user data towards host 1302. In step 1322, host 1302 receives the user data carried in the transmission initiated by UE 1306.

One or more of the various embodiments improve the performance of OTT services provided to UE 1306 using OTT connection 1350, in which wireless connection 1370 forms the last segment. More precisely, embodiments can facilitate mobile network operators (MNOs) to apply congestion-aware traffic optimization (CATO) techniques with various granularity levels, such as per application, per subscriber, per subscriber group, per RAN node, etc. Embodiments can be applied locally (e.g., a UPF-associated NWDAF) and without the need for RAN data collection by O&M. Embodiments can also reduce latency in congestion detection compared to conventional approaches. At a high level, embodiments promote more efficient use of network resources and improve quality of experience (QoE) for end users. These improvements increase the value of OTT services delivered via the network to both service providers and end users.

In an example scenario, factory status information may be collected and analyzed by host 1302. As another example, host 1302 may process audio and video data which may have been retrieved from a UE for use in creating maps. As another example, host 1302 may collect and analyze real-time data to assist in controlling vehicle congestion (e.g., controlling traffic lights). As another example, host 1302 may store surveillance video uploaded by a UE. As another example, host 1302 may store or control access to media content such as video, audio, VR or AR which it can broadcast, multicast or unicast to UEs. As other examples, host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1350 between host 1302 and UE 1306, in response to variations in the measurement results. The measurement procedure and/or the network functionality for reconfiguring the OTT connection may be implemented in software and hardware of host 1302 and/or UE 1306. In some embodiments, sensors (not shown) may be deployed in or in association with other devices through which OTT connection 1350 passes; the sensors may participate in the measurement procedure by supplying values of the monitored quantities exemplified above, or supplying values of other physical quantities from which software may compute or estimate the monitored quantities. The reconfiguring of OTT connection 1350 may include message format, retransmission settings, preferred routing etc.; the reconfiguring need not directly alter the operation of network node 1304. Such procedures and functionalities may be known and practiced in the art. In certain embodiments, measurements may involve proprietary UE signaling that facilitates measurements of throughput, propagation times, latency and the like, by host 1302. The measurements may be implemented in that software causes messages to be transmitted, in particular empty or ‘dummy’ messages, using OTT connection 1350 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, etc., such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:

A1. A method for network data analytics function (NWDAF) of a communication network, the method comprising:
receiving, from user plane function (UPF) of the communications network, a first subscription request for an analytic related to user plane (UP) traffic congestion;
sending, to the UPF, a second subscription request for information related to traffic between the UPF and a radio access network (RAN);
receiving the traffic-related information from the UPF, in accordance with the second subscription request;
computing the analytic related to UP traffic congestion, based on the received traffic-related information; and
sending the computed analytic to the UPF, in accordance with the first subscription request.
   A2. The method of embodiment A1, wherein the first subscription request includes the following:
an identifier of the analytic;
an identifier of a tunnel between the UPF and the RAN, for which the analytic is requested;
identifiers of one or more user equipment (UEs), for which the analytic is requested;
one or more other filtering criteria associated with the analytic;
one or more reporting criteria associated with the analytic;
a time period associated with the analytic; and
a required confidence level for the analytic.
   A3. The method of embodiment A2, wherein the second subscription request includes an event identifier associated with the second subscription request and identifiers of one or more of the following, for which the traffic-related information is requested:
a range of tunnels between the UPF and a RAN node, indicated by a tunnel range identifier or by an identifier of the RAN node;
one or more user equipment (UEs);
one or more applications; and
one or more application types.
   A4. The method of embodiment A3, further comprising determining the range of tunnels indicated in the second subscription request based on the identifier of the UPF tunnel in the first subscription request.
   A5. The method of any of embodiments A3-A4, wherein the traffic-related information received from the UPF includes the following:
aggregated volume of data traffic carried over the range of tunnels;
one or more key performance indicators (KPIs) for the aggregated data traffic carried over the range of tunnels; and
one or more of the following information associated with respective data flows carried over the range of tunnels: an identifier of a UE, an identifier of an application, flow data volume, flow start and stop times, flow duration, number of packets, average packet size, and other flow information relevant to congestion.
   A6. The method of embodiment A5, wherein the one or more KPIs include round trip time (RTT).
   A7. The method of any of embodiments A5-A6, wherein the analytic is a congestion level.
   A8. The method of embodiment A7, wherein the congestion level is sent to the UPF according to one of the following:
based on the congestion level exceeding a reporting threshold identified in the frst subscription request; or
periodically, according to a reporting period identified in the first subscription request.
   A9. The method of any of embodiments A7-A8, wherein the congestion level is sent to the UPF together with one or more of the following:
one or more suggested action for the UPF, based on the congestion level;
one or more KPIs associated with the congestion level;
one or more statistics for user data sessions;
identifiers of active ones of the UEs identified in the first subscription request; and
level of confidence associated with the congestion level.
   A10. The method of embodiment A9, wherein the one or more suggested actions include any of the following: adaptive bit rate (ABR) shaping, large flow shaping, transmission control protocol (TCP) traffic optimization, and QUIC traffic optimization.
   A11. The method of any of embodiments A5-A10, wherein
multiple reports of traffic-related information are received from the UPF in accordance with the second subscription request;
each report includes an aggregated volume of data traffic carried over the range of tunnels; and
computing the analytic comprises determining a congestion level based on variations in the reported aggregate volumes of data traffic.
   B1. A method for a user plane function (UPF) of a communication network, the method comprising:
sending, to a network data analytics function (NWDAF) of the communications network, a first subscription request for an analytic related to user plane (UP) traffic congestion;
receiving, from the NWDAF, a second subscription request for information related to traffic between the UPF and a radio access network (RAN);
sending the traffic-related information to the NWDAF, in accordance with the second subscription request; and
receiving the analytic from the NWDAF, in accordance with the first subscription request.
   B2. The method of embodiment B1, wherein the first subscription request includes the following:
an identifier of the analytic;
an identifier of a tunnel between the UPF and the RAN, for which the analytic is requested;
identifiers of one or more user equipment (UEs), for which the analytic is requested;
one or more other filtering criteria associated with the analytic;
one or more reporting criteria associated with the analytic;
a time period associated with the analytic; and
a required confidence level for the analytic.
   B3. The method of embodiment B2, wherein the second subscription request includes an event identifier associated with the second subscription request and identifiers of one or more of the following, for which the traffic-related information is requested:
a range of tunnels between the UPF and a RAN node, indicated by a tunnel range identifier or by an identifier of the RAN node;
one or more user equipment (UEs);
one or more applications; and
one or more application types.
   B4. The method of embodiment B3, wherein the traffic-related information received from the UPF includes one or more of the following:
aggregated volume of data traffic carried over the range of tunnels;
one or more key performance indicators (KPIs) for the aggregated data traffic carried over the range of tunnels; and
one or more of the following information associated with respective data flows carried over the range of tunnels: an identifier of a UE, an identifier of an application, flow data volume, flow start and stop times, flow duration, number of packets, average packet size, and other flow information relevant to congestion.
   B5. The method of embodiment B4, wherein the one or more KPIs include round trip time (RTT).
   B6. The method of any of embodiments B4-B5, wherein the analytic is a congestion level.
   B7. The method of embodiment B6, wherein the congestion level is received from the NWDAF according to one of the following:
based on the congestion level exceeding a reporting threshold identified in the frst subscription request; or
periodically, according to a reporting period identified in the first subscription request.
   B8. The method of any of embodiments B6-B7, wherein the congestion level is received from the NWDAF together with one or more of the following:
one or more suggested actions for the UPF, based on the congestion level;
one or more KPIs associated with the congestion level;
one or more statistics for user data sessions;
identifiers of active ones of the UEs identified in the first subscription request; and
level of confidence associated with the congestion level.
   B9. The method of embodiment B8, wherein the one or more suggested actions include any of the following: adaptive bit rate (ABR) shaping, large flow shaping, transmission control protocol (TCP) traffic optimization, and QUIC traffic optimization.
   B10. The method of any of embodiments B4-B9, wherein:
the multiple reports of traffic-related information are sent to the NWDAF in accordance with the second subscription request;
each report includes an aggregated volume of data traffic carried over the range of tunnels; and
the congestion level is based on variations in the reported aggregate volumes of data traffic.
   B11. The method of any of embodiments B1-B10, further comprising performing one or more of the following optimization operations on traffic between the UPF and the RAN, based the analytic: adaptive bit rate (ABR) shaping, large flow shaping, transmission control protocol (TCP) traffic optimization, and QUIC traffic optimization.
   B12. The method of any of embodiments B2-B11, further comprising:
receiving, from a session management function (SMF) of the communication network, a packet forwarding control protocol (PFCP) session establishment request that indicates a congestion-aware traffic optimization (CATO) policy; and
establishing the tunnel between the UPF and the RAN, in accordance with the PCFP session establishment request,
wherein the first subscription request is sent in response to establishing the tunnel.
   B13. The method of embodiment B12, further comprising sending, to the SMF, an indication that the UPF supports a CATO capability, wherein the PFCP session establishment request is received based on the indication.
   B14. The method of any of embodiments B12-B13, wherein the PFCP session establishment request indicates that the UPF should apply the CATO policy without further interaction with the SMF.
   B15. The method of any of embodiments B1-B14, further comprising initiating collection of the traffic-related information based on detecting data traffic corresponding to the second subscription request.
   B16. The method of embodiment B14, wherein the detected data traffic is associated with one or more of the following identified in the second subscription request: a UE, and an application.
   C1. A method for a session management function (SMF) of a communication network, the method comprising:
receiving, from an access and mobility management function (AMF) of the communication network, a request to create a protocol data unit (PDU) session for a user equipment (UE);
sending, to a policy control function (PCF) of the communication network, a request for session management (SM) policies related to the PDU session;
receiving, from the PCF, a response that includes a congestion-aware traffic optimization (CATO) policy applicable to the PDU session; and
sending, to a user plane function (UPF) of the communication network, a packet forwarding control protocol (PFCP) session establishment request that relates to the PDU session and that indicates the CATO policy.
   C2. The method of embodiment C1, further comprising:
receiving, from the UPF, an indication that the UPF supports a CATO capability; and
selecting the UPF for establishment of the PFCP session based on the indication.
   C3. The method of any of embodiments C1-C2, wherein the response from the PCF indicates that the SMF should apply the CATO policy without further interaction with the PCF.
   D1. A method for a policy control function (PCF) of a communication network, the method comprising:
receiving, from a session management function (SMF) of the communication network, a request for session management (SM) policies related to a protocol data unit (PDU) session for a user equipment (UE);
retrieving the SM policies for the PDU session from a unified data repository (UDR) of the communication network, wherein the retrieved SM policies include a congestion-aware traffic optimization (CATO) policy; and
sending, to the SMF, a response that includes the CATO policy.
   D2. The method of embodiment D1, wherein the response to the SMF indicates that the SMF should apply the CATO policy without further interaction with the PCF.
   E1. A network data analytics function (NWDAF) of a communication network, wherein:
the NWDAF is implemented by communication interface circuitry and processing circuitry that are operably coupled; and
the processing circuitry and interface circuitry are configured to perform operations corresponding to any of the methods of embodiments A1-A11.
   E2. A network data analytics function (NWDAF) of a communication network, the NWDAF being configured to perform operations corresponding to any of the methods of embodiments A1-A11.
   E3. A non-transitory, computer-readable medium storing computer-executable instructions that, when executed by processing circuitry associated with a network data analytics function (NWDAF) of a communication network, configure the MTLF to perform operations corresponding to any of the methods of embodiments A1-A11.
   E4. A computer program product comprising computer-executable instructions that, when executed by processing circuitry associated with a network data analytics function (NWDAF) of a communication network, configure the MTLF to perform operations corresponding to any of the methods of embodiments A1-A11.
   F1. A user plane function (UPF) of a communication network, wherein:
the UPF is implemented by communication interface circuitry and processing circuitry that are operably coupled; and
the processing circuitry and interface circuitry are configured to perform operations corresponding to any of the methods of embodiments B1-B16.
   F2. A user plane function (UPF) of a communication network, the UPF being configured to perform operations corresponding to any of the methods of embodiments B1-B16.
   F3. A non-transitory, computer-readable medium storing computer-executable instructions that, when executed by processing circuitry associated with a user plane function (UPF) of a communication network, configure the AnLF to perform operations corresponding to any of the methods of embodiments B1-B16.
   F4. A computer program product comprising computer-executable instructions that, when executed by processing circuitry associated with a user plane function (UPF) of a communication network, configure the AnLF to perform operations corresponding to any of the methods of embodiments B1-B16.
   G1. A session management function (SMF) of a communication network, wherein:
the SMF is implemented by communication interface circuitry and processing circuitry that are operably coupled; and
the processing circuitry and interface circuitry are configured to perform operations corresponding to any of the methods of embodiments C1-C3.
   G2. A session management function (SMF) of a communication network, the SMF being configured to perform operations corresponding to any of the methods of embodiments C1-C3.
   G3. A non-transitory, computer-readable medium storing computer-executable instructions that, when executed by processing circuitry associated with a session management function (SMF) of a communication network, configure the SMF to perform operations corresponding to any of the methods of embodiments C1-C3.
   G4. A computer program product comprising computer-executable instructions that, when executed processing circuitry associated with a session management function (SMF) of a communication network, configure the SMF to perform operations corresponding to any of the methods of embodiments C1-C3.
   H1. A policy control function (PCF) of a communication network, wherein:
the PCF is implemented by communication interface circuitry and processing circuitry that are operably coupled; and
the processing circuitry and interface circuitry are configured to perform operations corresponding to any of the methods of embodiments D1-D2.
   H2. A policy control function (PCF) of a communication network, the SMF being configured to perform operations corresponding to any of the methods of embodiments D1-D2.
   H3. A non-transitory, computer-readable medium storing computer-executable instructions that, when executed by processing circuitry associated with a policy control function (PCF) of a communication network, configure the PCF to perform operations corresponding to any of the methods of embodiments D1-D2.
   H4. A computer program product comprising computer-executable instructions that, when executed by processing circuitry associated with a policy control function (PCF) of a communication network, configure the PCF to perform operations corresponding to any of the methods of embodiments D1-D2.

1. A method for a network data analytics function, NWDAF, of a communication network, the method comprising:
receiving, from a user plane function, UPF, of the communication network, a first subscription request for an analytic related to user plane, UP, traffic congestion, the first subscription request including the following:
an identifier of the analytic;
an identifier of a tunnel between the UPF and a Radio Access Network, RAN, for which the analytic is requested:
identifiers of one or more user equipment, UEs, for which the analytic is requested;
one or more other filtering criteria associated with the analytic;
one or more reporting criteria associated with the analytic;
a time period associated with the analytic; and
a required confidence level for the analytic;
sending, to the UPF, a second subscription request for information related to traffic between the UPF and, the RAN, the second subscription request including an event identifier associated with the second subscription request and identifiers of one or more of the following, for which the traffic-related information is requested:
a range of tunnels between the UPF and the RAN node, indicated by a tunnel range identifier or by an identifier of the RAN node;
one or more user equipment, UEs;
one or more applications; and
one or more application types;
receiving the traffic-related information from the UPF, in accordance with the second subscription request;
computing the analytic related to UP traffic congestion, based on the received traffic-related information; and
sending the computed analytic to the UPF, in accordance with the first subscription request.

2. (canceled)

3. (canceled)

4. The method of claim 1, further comprising determining the range of tunnels indicated in the second subscription request based on the identifier of the UPF tunnel in the first subscription request.

5. The method of claim 1, wherein the traffic-related information received from the UPF includes the following:
aggregated volume of data traffic carried over the range of tunnels;
one or more key performance indicators, KPIs, for the aggregated data traffic carried over the range of tunnels; and
one or more of the following information associated with respective data flows carried over the range of tunnels: an identifier of a UE, an identifier of an application, flow data volume, flow start and stop times, flow duration, number of packets, average packet size, and other flow information relevant to congestion.

6. The method of claim 5, wherein one or more of the following applies:
the one or more KPIs include round trip time, RTT; and
the analytic is a congestion level.

7. The method of claim 6, wherein the congestion level is sent to the UPF according to one of the following:
based on the congestion level exceeding a reporting threshold identified in the first subscription request; or
periodically, according to a reporting period identified in the first subscription request.

8. The method of claim 6, wherein the congestion level is sent to the UPF together with one or more of the following:
one or more suggested action for the UPF, based on the congestion level;
one or more KPIs associated with the congestion level;
one or more statistics for user data sessions;
identifiers of active ones of the UEs identified in the first subscription request; and
level of confidence associated with the congestion level.

9. The method of claim 8, wherein the one or more suggested actions include any of the following: adaptive bit rate, ABR, shaping; large flow shaping; transmission control protocol, TCP, traffic optimization; and QUIC traffic optimization.

10. The method of claim 5, wherein:
multiple reports of traffic-related information are received from the UPF in accordance with the second subscription request;
each report includes an aggregated volume of data traffic carried over the range of tunnels; and
computing the analytic comprises determining a congestion level based on variations in the reported aggregate volumes of data traffic.

11. A method for a user plane function, UPF, of a communication network, the method comprising:
sending, to a network data analytics function, NWDAF, of the communication network, a first subscription request for an analytic related to user plane, UP, traffic congestion, the first subscription request including the following:
an identifier of the analytic;
an identifier of a tunnel between the UPF and a Radio Access Network, RAN, for which the analytic is requested;
identifiers of one or more user equipment, UEs, for which the analytic is requested;
one or more other filtering criteria associated with the analytic;
one or more reporting criteria associated with the analytic;
a time period associated with the analytic; and
a required confidence level for the analytic;
receiving, from the NWDAF, a second subscription request for information related to traffic between the UPF and RAN, the second subscription request including an event identifier associated with the second subscription request and identifiers of one or more of the following, for which the traffic-related information is requested:
a range of tunnels between the UPF and the RAN node, indicated by a tunnel range identifier or by an identifier of the RAN node;
one or more user equipment, UEs;
one or more applications; and
one or more application types;
sending the traffic-related information to the NWDAF, in accordance with the second subscription request; and
receiving the analytic from the NWDAF, in accordance with the first subscription request.

12. (canceled)

13. (canceled)

14. The method of claim 11, wherein the traffic-related information received from the UPF includes one or more of the following:
aggregated volume of data traffic carried over the range of tunnels;
one or more key performance indicators, KPIs, for the aggregated data traffic carried over the range of tunnels; and
one or more of the following information associated with respective data flows carried over the range of tunnels: an identifier of a UE, an identifier of an application, flow data volume, flow start and stop times, flow duration, number of packets, average packet size, and other flow information relevant to congestion.

15. The method of claim 14, wherein one or more of the following applies:
the one or more KPIs include round trip time, RTT; and
the analytic is a congestion level.

16. The method of claim 15, wherein the congestion level is received from the NWDAF according to one of the following:
based on the congestion level exceeding a reporting threshold identified in the first subscription request; or
periodically, according to a reporting period identified in the first subscription request.

17. The method of claim 15, wherein the congestion level is received from the NWDAF together with one or more of the following:
one or more suggested actions for the UPF, based on the congestion level;
one or more KPIs associated with the congestion level;
one or more statistics for user data sessions;
identifiers of active ones of the UEs identified in the first subscription request; and
level of confidence associated with the congestion level.

18. (canceled)

19. The method of claim 14, wherein:
the multiple reports of traffic-related information are sent to the NWDAF in accordance with the second subscription request;
each report includes an aggregated volume of data traffic carried over the range of tunnels; and
the congestion level is based on variations in the reported aggregate volumes of data traffic.

20. The method of claim 11, further comprising performing one or more of the following optimization operations on traffic between the UPF and the RAN, based the analytic: adaptive bit rate, ABR, shaping; large flow shaping; transmission control protocol, TCP, traffic optimization; and QUIC traffic optimization.

21. The method of claim 11, further comprising:
receiving, from a session management function, SMF, of the communication network, a packet forwarding control protocol, PFCP, session establishment request that indicates a congestion-aware traffic optimization, CATO, policy; and
establishing the tunnel between the UPF and the RAN, in accordance with the PCFP session establishment request,
wherein the first subscription request is sent in response to establishing the tunnel.

22. The method of claim 21, further comprising sending to the SMF an indication that the UPF supports a CATO capability, wherein the PFCP session establishment request is received based on the indication, wherein the PFCP session establishment request indicates that the UPF should apply the CATO policy without further interaction with the SMF.

23. (canceled)

24. The method of claim 11, further comprising initiating collection of the traffic-related information based on detecting data traffic corresponding to the second subscription request, wherein the detected data traffic is associated with one or more of the following identified in the second subscription request: a UE, and an application.

25.-27. (canceled)

28. A network data analytics function, NWDAF configured to operate in a communication network, the NWDAF being further configured to:
receive, from a user plane function, UPF of the communication network, a first subscription request for an analytic related to user plane, UP, traffic congestion, the first subscription request including the following:
an identifier of the analytic;
an identifier of a tunnel between the UPF and a Radio Access Network, RAN, for which the analytic is requested;
identifiers of one or more user equipment, UEs, for which the analytic is requested;
one or more other filtering criteria associated with the analytic;
one or more reporting criteria associated with the analytic;
a time period associated with the analytic; and
a required confidence level for the analytic;
send, to the UPF, a second subscription request for information related to traffic between the UPF and the RAN, the second subscription request including an event identifier associated with the second subscription request and identifiers of one or more of the following, for which the traffic-related information is requested:
a range of tunnels between the UPF and the RAN node, indicated by a tunnel range identifier or by an identifier of the RAN node;
one or more user equipment, UEs;
one or more applications; and
one or more application types;
receive the traffic-related information from the UPF, in accordance with the second subscription request;
compute the analytic related to UP traffic congestion, based on the received traffic-related information; and
send the computed analytic to the UPF, in accordance with the first subscription request.

29.-33. (canceled)

34. A user plane function, UPF configured to operate in a communication network, the UPF being further configured to:
send, to a network data analytics function, NWDAF of the communication network, a first subscription request for an analytic related to user plane, UP, traffic congestion, the first subscription request including the following:
an identifier of the analytic;
an identifier of a tunnel between the UPF and a Radio Access Network, RAN, for which the analytic is requested;
identifiers of one or more user equipment, UEs, for which the analytic is requested;
one or more other filtering criteria associated with the analytic;
one or more reporting criteria associated with the analytic;
a time period associated with the analytic; and
a required confidence level for the analytic;
receive, from the NWDAF, a second subscription request for information related to traffic between the UPF and the RAN, the second subscription request including an event identifier associated with the second subscription request and identifiers of one or more of the following, for which the traffic-related information is requested:
a range of tunnels between the UPF and the RAN node, indicated by a tunnel range identifier or by an identifier of the RAN node;
one or more user equipment, UEs;
one or more applications; and
one or more application types;
send the traffic-related information to the NWDAF, in accordance with the second subscription request; and
receive the analytic from the NWDAF, in accordance with the first subscription request.

35.-37. (canceled)
